(19) United States
(12) Patent Application Publication
(10) Pub. No.: US 2017/0250416 A1
(43) Pub. Date: Aug. 31, 2017

(54) FUEL CELL CONTROL METHOD AND FUEL CELL SYSTEM

(71) Applicant: HONDA MOTOR CO., LTD., Tokyo (JP)

(72) Inventors: Shinya WATANABE, Wako (JP); Akiji ANDO, Wako (JP)

(73) Assignee: HONDA MOTOR CO., LTD., Tokyo (JP)

(21) Appl. No.: 15/410,767

(22) Filed: Jan. 20, 2017

(30) Foreign Application Priority Data
Feb. 29, 2016 (JP) 2016-037327

(51) Int. Cl. H01M 8/04119; H01M 8/04537

(52) U.S. Cl. CPC H01M 8/04179; H01M 8/04641; H01M 2008/1095

(57) ABSTRACT

A fuel cell control method includes detecting a state value indicating a state in a fuel cell during an operation of the fuel cell. The fuel cell includes a membrane electrode assembly and a separator stacked on the membrane electrode assembly. The membrane electrode assembly includes a solid polymer electrolyte membrane sandwiched between an anode electrode and a cathode electrode. It is determined whether a liquid connects the solid polymer electrolyte membrane and the separator based on the state value detected. The fuel cell is dried in a case where it is determined that the liquid connects the solid polymer electrolyte membrane and the separator.

### CROSS-REFERENCE TO RELATED APPLICATIONS

The present application claims priority under 35 U.S.C. §119 to Japanese Patent Application No. 2016-037327, filed Feb. 29, 2016, entitled “FUEL CELL CONTROL METHOD AND FUEL CELL SYSTEM.” The contents of this application are incorporated herein by reference in their entirety.

### BACKGROUND

1. Field

The present disclosure relates to a fuel cell control method and a fuel cell system.

2. Description of the Related Art

In a fuel cell system, when a reaction gas flow passage of a fuel cell comes into a water excessive state, a phenomenon impeding, e.g., a flow of reaction gas (called flooding) occurs, and stability in power generation degrades. In view of the above point, a fuel cell system disclosed in Japanese Unexamined Patent Application Publication No. 2014-32797, for example, employs a technique of measuring an impedance of a fuel cell, detecting the flooding, and adjusting a back pressure of cathode gas on the basis of a detection result.

### SUMMARY

According to a first aspect of the present invention, a fuel cell control method includes a detected value obtaining step of, during an operation of a fuel cell including membrane electrode assemblies and separators stacked successively, detecting a status variable of the fuel cell and obtaining a detected value of the status variable, each of the membrane electrode assemblies including a solid polymer electrolyte membrane sandwiched between an anode electrode and a cathode electrode. The fuel cell control method includes a liquid junction determination step of determining, on the basis of the detected and obtained value, whether a state of liquid junction in which the solid polymer electrolyte membrane and the separator are interconnected through a liquid occurs. The fuel cell control method includes a liquid junction elimination control step of performing an operation of making the fuel cell dried when the occurrence of the liquid junction is determined.

According to a second aspect of the present invention, a fuel cell system including a fuel cell that includes membrane electrode assemblies and separators stacked successively, each of the membrane electrode assemblies including a solid polymer electrolyte membrane sandwiched between an anode electrode and a cathode electrode, the fuel cell system includes a detected value obtaining unit, a liquid junction determination unit, and a liquid junction elimination control unit. The detected value obtaining unit, during an operation of the fuel cell, detects a status variable of the fuel cell and obtaining a detected value of the status variable. The liquid junction determination unit determines on the basis of the detected and obtained value, whether a state of liquid junction in which the solid polymer electrolyte membrane and the separator are interconnected through a liquid occurs. The liquid junction elimination control unit of performing an operation of making the fuel cell dried when the occurrence of the liquid junction is determined.

According to a third aspect of the present invention, a fuel cell control method includes detecting a state value indicating a state in a fuel cell during an operation of the fuel cell. The fuel cell includes a membrane electrode assembly and a separator stacked on the membrane electrode assembly. The membrane electrode assembly includes a solid polymer electrolyte membrane sandwiched between an anode electrode and a cathode electrode. It is determined whether a liquid connects the solid polymer electrolyte membrane and the separator based on the state value detected. The fuel cell is dried in a case where it is determined that the liquid connects the solid polymer electrolyte membrane and the separator.

According to a fourth aspect of the present invention, a fuel cell system includes a fuel cell, a detector, and circuitry. The fuel cell includes a membrane electrode assembly and a separator. The membrane electrode assembly includes a solid polymer electrolyte membrane sandwiched between an anode electrode and a cathode electrode. The separator is stacked on the membrane electrode assembly. The detector detects a state value indicating a state in a fuel cell during an operation of the fuel cell. The circuitry is configured to determine whether a liquid connects the solid polymer electrolyte membrane and the separator based on the state value detected. The circuitry is configured to dry the fuel cell in a case where it is determined that the liquid connects the solid polymer electrolyte membrane and the separator.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic explanatory view of a fuel cell system according to an embodiment of the present application.

FIG. 2A is an explanatory view illustrating reactions of elements during power generation of a fuel cell stack, and FIG. 2B is an explanatory view illustrating a state of the liquid junction in the fuel cell stack.

FIG. 3 is a graph depicting changes in impedance and amount of dew condensation water during high-load continuous power generation of the fuel cell stack.

FIG. 4 is a graph depicting changes in current and count of a high-load counter during the high-load continuous power generation of the fuel cell stack.

FIG. 5 is a graph depicting changes in temperature and amount of dew condensation water during power generation in a not-yet-warmed-up state of the fuel cell stack.

FIG. 6 is a functional block diagram illustrating an inner configuration of a control unit in the fuel cell system to execute liquid junction determination control.

FIG. 7 is a flowchart illustrating procedures of the liquid junction determination control in the fuel cell system.

### DESCRIPTION OF THE EMBODIMENTS

The embodiments will now be described with reference to the accompanying drawings, wherein like reference numerals designate corresponding or identical elements throughout the various drawings.

A fuel cell system according to the present application will be described in detail below by referring to the attached drawings in connection with an embodiment that is preferred from the viewpoint of implementing a fuel cell control method.

A fuel cell system 10 according to one embodiment is installed in a fuel cell vehicle, such as a fuel cell electric car. It is to be noted that the fuel cell system 10 is not limited to use in vehicles, and it may be used in various applications including stationary equipment.

The fuel cell system 10 includes a fuel cell stack 12 (fuel cell). The fuel cell stack 12 is connected with a fuel gas supply device 14 that supplies hydrogen gas as fuel gas, an oxidant gas supply device 16 that supplies air as oxidant gas, and a coolant supply device 18 that supplies a coolant. The fuel cell system 10 further includes a battery 20 that is an energy storage device, and a control unit 22 that is a system controller.

The fuel cell stack 12 includes a plurality of power generation cells 24 stacked successively in a horizontal direction or a vertical direction. The power generation cells 24 are each constituted by a membrane electrode assembly 26, a first separator 28, and a second separator 30, both the separators sandwiching the membrane electrode assembly 26 therebetween. The first and second separators 28 and 30 are each constituted by a metal separator or a carbon separator. In other words, the fuel cell stack 12 has a casing in which there is a structure obtained by repeatedly stacking the first separator 28, the membrane electrode assembly 26, and the second separator 30. The fuel cell stack 12 is not limited to the structure including two separators (i.e., the first separator 28 and the second separator 30) arranged between the adjacent membrane electrode assemblies 26, and it may have a structure including only one separator arranged therebetween.

The membrane electrode assembly 26 includes a solid polymer electrolyte membrane (proton exchange membrane=PEM) 32 that is, for example, a thin film made of a perfluorosulfonic acid and containing moisture, an anode electrode 34, and a cathode electrode 36, both the electrodes 34 and 36 sandwiching the solid polymer electrolyte membrane 32 therebetween. The solid polymer electrolyte membrane 32 may be made of a fluorine-based electrolyte or a HC (hydrocarbon)-based electrolyte.

The first separator 28 provides, between itself and the membrane electrode assembly 26, a hydrogen gas flow passage 38 through which hydrogen gas is supplied to the anode electrode 34. The second separator 30 provides, between itself and the membrane electrode assembly 26, an air flow passage 40 through which air is supplied to the cathode electrode 36. A coolant flow passage 42 allowing a coolant to flow therethrough is disposed between the first separator 28 and the second separator 30 adjacent to each other.

The fuel cell stack 12 has a hydrogen gas inlet 44a, a hydrogen gas outlet 44b, an air inlet 46a, an air outlet 46b, a coolant inlet 48a, and a coolant outlet 48b. The hydrogen gas inlet 44a penetrates through each power generation cell 24 in the stacking direction, and it is communicated with the supply side of the hydrogen gas flow passage 38. The hydrogen gas outlet 44b penetrates through each power generation cell 24 in the stacking direction, and it is communicated with the discharge side of the hydrogen gas flow passage 38. An anode flow passage is constituted by the hydrogen gas flow passage 38, the hydrogen gas inlet 44a, and the hydrogen gas outlet 44b.

The air inlet 46a penetrates through each power generation cell 24 in the stacking direction, and it is communicated with the supply side of the air flow passage 40. The air outlet 46b penetrates through each power generation cell 24 in the stacking direction, and it is communicated with the discharge side of the air flow passage 40. A cathode flow passage is constituted by the air flow passage 40, the air inlet 46a, and the air outlet 46b.

The coolant inlet 48a penetrates through each power generation cell 24 in the stacking direction, and it is communicated with the supply side of the coolant flow passage 42. The coolant outlet 48b penetrates through each power generation cell 24 in the stacking direction, and it is communicated with the discharge side of the coolant flow passage 42.

The fuel gas supply device 14 includes a hydrogen tank 50 that stores hydrogen under high pressure. The hydrogen tank 50 is communicated with the hydrogen gas inlet 44a of the fuel cell stack 12 through a hydrogen gas supply passage 52. The hydrogen gas supply passage 52 supplies the hydrogen gas to the fuel cell stack 12.

An injector 54 and an ejector 56 are disposed in the hydrogen gas supply passage 52 in series. Furthermore, a bypass supply passage 58 is connected to the hydrogen gas supply passage 52 in a bypassing relation to both the injector 54 and the ejector 56. A BP (bypass) injector 60 is disposed in the bypass supply passage 58. The BP injector 60 serves as a sub-injector that is used to supply a high concentration of hydrogen, for example, at startup of the fuel cell stack 12 or in response to a demand for high-load continuous power generation. On the other hand, the injector 54 serves as a main injector that is mainly used during ordinary power generation.

A hydrogen gas discharge passage 62 is communicated with the hydrogen gas outlet 44b of the fuel cell stack 12. The hydrogen gas discharge passage 62 guides waste hydrogen gas, at least part of which has been used by the anode electrode 34, to be discharged from the fuel cell stack 12. A gas-liquid separator 64 is connected to the hydrogen gas discharge passage 62. The ejector 56 is also connected to the hydrogen gas discharge passage 62 through a hydrogen circulation flow passage 66 that is branched from the hydrogen gas discharge passage 62 at a point downstream of the gas-liquid separator 64. A hydrogen pump 68 is disposed in the hydrogen circulation flow passage 66. At the startup, particularly, the hydrogen gas pump 68 circulates the waste hydrogen gas, which has been discharged to the hydrogen gas discharge passage 62, to the hydrogen gas supply passage 52 through the hydrogen circulation flow passage 66.

One end of a purge flow passage 70 is communicated with the downstream side of the hydrogen gas discharge passage 62, and a purge valve 72 is disposed midway the purge flow passage 70. One end of a waste water flow passage 74 through which a fluid mainly containing liquid components is discharged is connected to a bottom portion of the gas-liquid separator 64. A drain valve 76 is disposed midway the waste water flow passage 74.

The oxidant gas supply device 16 includes an air pump 78 that compresses air taken from the atmosphere and that supplies the compressed air. The air pump 78 is disposed in an air supply passage 80. The air supply passage 80 supplies the air to the fuel cell stack 12.

In the air supply passage 80, a supply-side on-off valve 82a and a humidifier 84 are disposed downstream of the air pump 78. The air supply passage 80 is communicated with the air inlet 46a of the fuel cell stack 12. A bypass supply passage 86 is connected to the air supply passage 80 in a bypassing relation to the humidifier 84. An on-off valve 88 is disposed in the bypass supply passage 86.

An air discharge passage 90 is communicated with the air outlet 46b of the fuel cell stack 12. The humidifier 84 for exchanging moisture and heat between the supplied air and the discharged air, a discharge-side on-off valve 82b, and a back pressure valve 92 are disposed in the air discharge passage 90. The air discharge passage 90 discharges, from the fuel cell stack 12, waste air at least part of which has been used by the cathode electrode 36. The other end of the purge flow passage 70 and the other end of the waste water flow passage 74 are connected to the downstream side of the air discharge passage 90, thus constituting a dilution section.

Opposite ends of a bypass flow passage 94 is communicated with the air supply passage 80 and the air discharge passage 90 at positions upstream of the supply-side on-off valve 82a and downstream of both the discharge-side on-off valve 82b and the back pressure valve 92, respectively. A BP flow rate adjustment valve 96 is disposed in the bypass flow passage 94 to adjust a flow rate of air flowing through the bypass flow passage 94. An air circulation flow passage 98 is communicated with the air supply passage 80 and the air discharge passage 90 at positions downstream of the supply-side on-off valve 82a and upstream of the discharge-side on-off valve 82b, respectively. A circulation pump 100 is disposed in the air circulation flow passage 98. The circulation pump 100 circulates the waste air, which has been discharged to the air discharge passage 90, to the air supply passage 80 through the air circulation flow passage 98.

The coolant supply device 18 includes a coolant supply passage 102 that is connected to the coolant inlet 48a of the fuel cell stack 12. A water pump 104 is disposed midway the coolant supply passage 102. The coolant supply passage 102 is connected to a radiator 106, and a coolant discharge passage 108 in communication with the coolant outlet 48b is also connected to the radiator 106.

### [Regarding Occurrence of Liquid Junction]

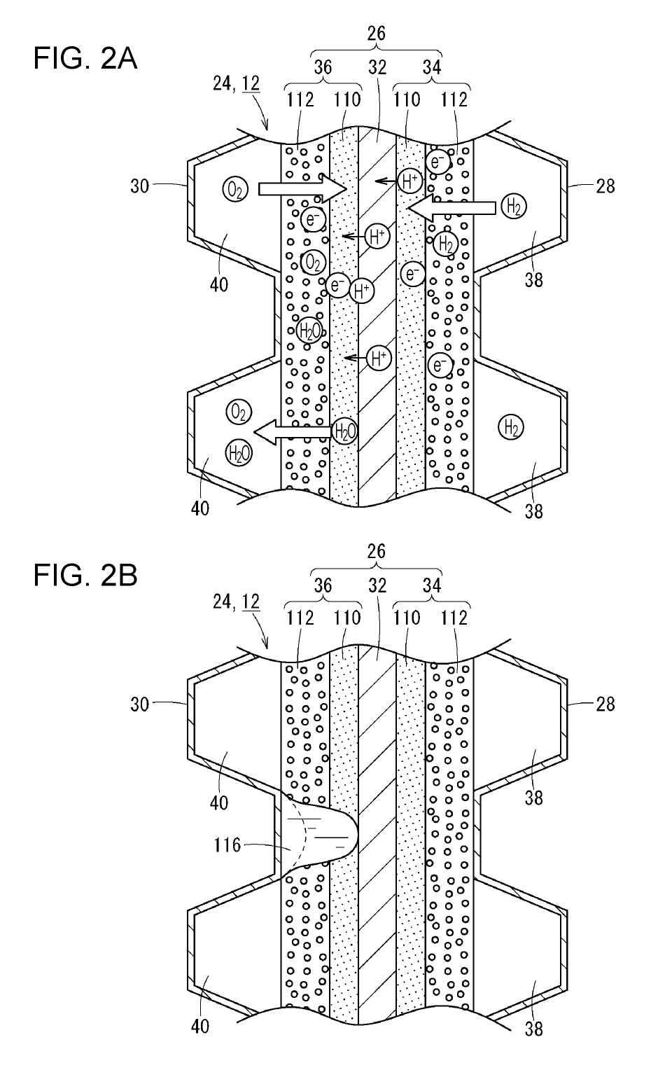

In the fuel cell system 10 thus constituted, a state of the above-described liquid junction occurs in some cases within the fuel cell stack 12 during operation. The liquid junction occurring in the fuel cell stack 12 will be described below with reference to FIGS. 2A and 2B.

The anode electrode 34 and the cathode electrode 36 in the membrane electrode assembly 26 are each constituted, for example, by successively stacking a catalyst layer 110 and a gas diffusion layer (GDL) 112 on the solid polymer electrolyte membrane 32 in the mentioned order toward the outside. The catalyst layer 110 acts to decompose, in the anode electrode 34, supplied hydrogen gas H₂ into protons H⁺ (ions of hydrogen atoms) and electrons e⁻, and to produce, in the cathode electrode 36, water H₂O (produced water or water vapor) from protons H⁺, electrons e⁻, and oxygen O₂. The gas diffusion layer 112 acts to diffuse gas (including hydrogen gas, air, and water vapor), thus causing the gas to flow toward the catalyst layer 110 or the separator side. The multilayer structure of the anode electrode 34 and the cathode electrode 36 is not limited to the above-described structure. In another example, a water repellent layer (not illustrated) may be disposed between the catalyst layer 110 and the gas diffusion layer 112.

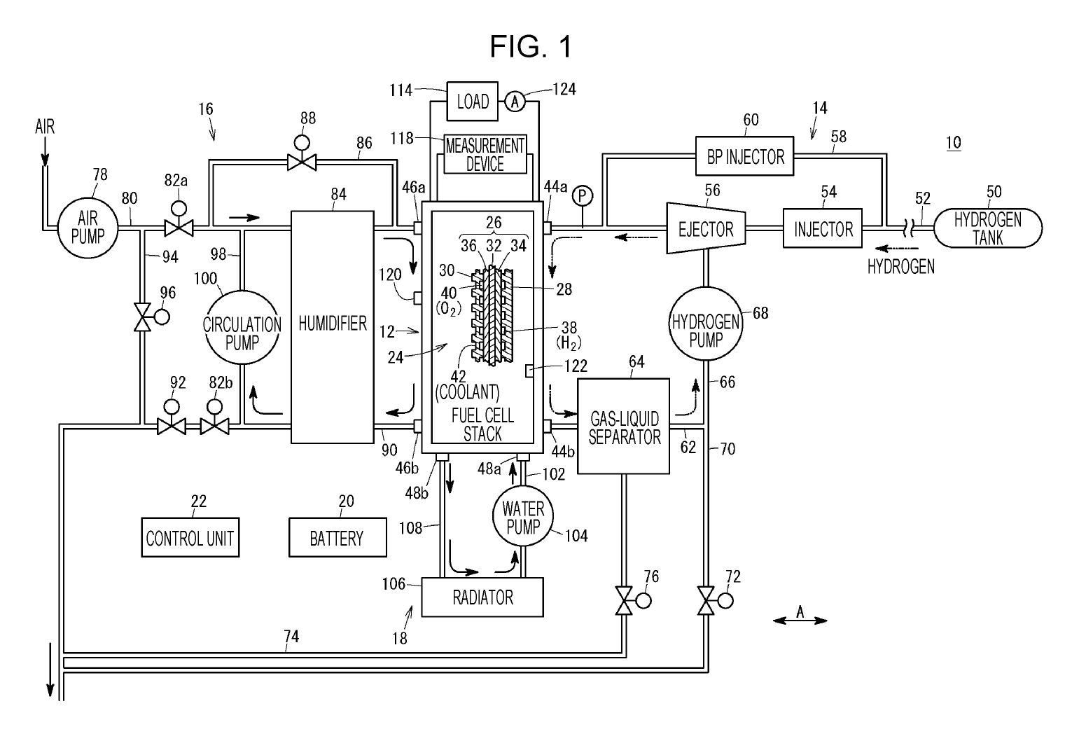

The solid polymer electrolyte membrane 32 in the membrane electrode assembly 26 allows protons H⁺ to move from the side including the anode electrode 34 toward the side including the cathode electrode 36, but blocks movement of electrons e⁻ and the gas therethrough. Because the electrons e⁻ decomposed on the side including the anode electrode 34 are blocked by the solid polymer electrolyte membrane 32, those electrons e⁻ are sent to the first separator 28. As a result, electric power is taken out from the fuel cell stack 12, and the electric power is supplied to a load 114 (see FIG. 1, including a battery 20), e.g., a motor of a fuel cell vehicle.

During power generation with the fuel cell stack 12, water H₂O produced in the cathode electrode 36 is discharged as water vapor to the outside of the fuel cell stack 12 through the air flow passage 40 together with air. Depending on states (e.g., operation conditions and temperature) of the fuel cell stack 12, however, a large amount of water H20 may be produced to cause dew condensation, and a liquid (dew condensation water 116) may accumulate as illustrated. In particular, with the presence of an excessive amount of the dew condensation water 116 in the air flow passage 40, the above-described flooding occurs.

Moreover, because a large amount of water H₂O is further present in the gas diffusion layer 112 and the catalyst layer 110 of the cathode electrode 36, the dew condensation water 116 is generated in the cathode electrode 36 as well. Continued accumulation of the dew condensation water 116 in the cathode electrode 36 brings about the state of the liquid junction in which the solid polymer electrolyte membrane 32 and the second separator 30 are interconnected through the dew condensation water 116. In the state of the liquid junction, there is a risk that metal ions may elute from the second separator 30 through the dew condensation water 116 (namely, ion contamination may occur). It is estimated that the state of the liquid junction occurs in an earlier stage than the occurrence of the flooding.

### [Configuration of Fuel Cell System to Determine Liquid Junction]

In consideration of the above point, the fuel cell system 10 is designed to execute a process of detecting a status variable of the fuel cell stack 12, determining the occurrence of the liquid junction on the basis of a detected value of the status variable, and performing control to eliminate the liquid junction. More specifically, as illustrated in FIG. 1, the fuel cell system 10 includes, as an implement for detecting the status variable, a measurement device 118 that measures an impedance of the fuel cell stack 12. The measurement device 118 includes, e.g., an AC generator, an AC ammeter, and an AC voltmeter (all not illustrated) to detect a current and a voltage in the fuel cell stack 12 and to calculate an impedance in accordance with an AC 4-terminal method.

The fuel cell system 10 further includes a temperature sensor 120 that detects a temperature of the fuel cell stack 12, and a humidity sensor 122 that detects a humidity in the fuel cell stack 12. Moreover, the fuel cell system 10 includes an ammeter 124 disposed in a wiring line between the fuel cell stack 12 and the load 114 to measure a current amount output from the fuel cell stack 12. Respective values detected by the measurement device 118, the temperature sensor 120, the humidity sensor 122, and the ammeter 124 are sent to the control unit 22.

The control unit 22 in the fuel cell system 10 executes a process for determining the occurrence of the liquid junction and eliminating the liquid junction on the basis of the values detected by the measurement device 118, the ammeter 124, the temperature sensor 120, and the humidity sensor 122. On that occasion, the control unit 22 determines an occurrence state of the liquid junction in accordance with the following determination concepts (A) to (C). The order in a list of the following determination concepts (A), (B) and (C) represents the order in a descending sequence from the highest priority (accuracy) of the determination. Thus, when the occurrence of the liquid junction is determined in accordance with the determination concept (A), the determination in accordance with the determination concept (A) has priority even if the occurrence of the liquid junction (or the dew condensation water) is not determined in accordance with the determination concept (C).

(A) When a water state (amount of the dew condensation water) in the fuel cell stack 12 can be ascertained, the occurrence of the liquid junction is determined on the basis of the ascertained water state.

(B) When the water state in the fuel cell stack 12 can be ascertained only in a limited way (for example, when the load 114 is increased to be so high as exceeding a measurable range of the ammeter 124), it is estimated that the dew condensation water is generated on condition of the load not lower than a predetermined level and the lapse of a predetermined time. However, the determination on the occurrence of the liquid junction regarding the final water state is preferably made while the predetermined time is changed depending on the amount of the generated dew condensation water (e.g., the load).

(C) When the water state in the fuel cell stack 12 cannot be ascertained, the water state is estimated from the temperature of the fuel cell stack 12. Thus, when the temperature of the fuel cell stack 12 is not higher than a predetermined temperature threshold for determination of dew condensation, it is determined that the dew condensation water is generated, and when the temperature of the fuel cell stack 12 is not lower than a predetermined temperature threshold for elimination of dew condensation, it is estimated that the dew condensation water is eliminated.

Furthermore, in the case of actually determining the occurrence of the liquid junction on the basis of the measured values, the control unit 22 sets a condition for the generation of the dew condensation water and a condition for the elimination of the dew condensation water (i.e., drying) for each of the above determination concepts (A) to (C). For example, when the dew condensation water is generated, a dew condensation rate (or time) on the basis of the load is set, and the amount of the dew condensation water is integrated. Then, the occurrence of the liquid junction is determined when an integrated value is not lower than a predetermined threshold. It is to be noted that, when liquid-junction elimination control for eliminating the liquid junction is not executed, the integrated value is kept until the start of a next operation even after the end of one operation.

An actual process of determining the occurrence of the liquid junction with the control unit 22 will be described below for each of several operation modes of the fuel cell system 10.

### [Determination of Liquid Junction in Ordinary Power Generation Mode]

In an ordinary power generation mode, the fuel cell system 10 can ascertain the water state in the fuel cell stack 12 on the basis of the impedance detected by the measurement device 118. The ordinary power generation mode implies, for example, low-load continuous power generation where power generation efficiency is relatively high after a warm-up and an amount of current supplied to the load 114 (i.e., the value detected by the ammeter 124) is not more than a predetermined value. A predetermined value for discrimination between the low-load continuous power generation and a high-load continuous power generation described later is, e.g., 100 A.

During the low-load continuous power generation, the impedance detected by the measurement device 118 reflects a wet or dry state in the fuel cell stack 12 in real time. Therefore, the control unit 22 can determine the occurrence of the liquid junction in accordance with the above determination concept (A). More specifically, when the impedance is not higher than a predetermined dew-condensation determination threshold (not illustrated), the control unit 22 can determine the generation of the dew condensation water. When the impedance is not higher than a predetermined liquid-junction determination threshold that is lower than the dew-condensation determination threshold, the control unit 22 can determine the occurrence of the liquid junction.

### [Determination of Liquid Junction in High-Load Continuous Power Generation Mode]

On the other hand, for example, when the fuel cell vehicle increases speed, the fuel cell system 10 performs the high-load continuous power generation in which a large current is supplied to the load 114. Thus, the high-load continuous power generation implies a situation in which the fuel cell stack 12 outputs a current of not lower than a predetermined value (e.g., 100 A) to the load 114. In such a situation, an amount of produced water H₂O exceeds an amount of water H₂O removed by air in the air flow passage 40 (i.e., an amount of discharged water) in the fuel cell stack 12. Moreover, during the high-load continuous power generation, the fuel cell system 10 stops impedance control for controlling the wet/dry state of the fuel cell stack 12, and performs the operation under the wet state. Accordingly, the humidity in the fuel cell stack 12 rises and water H₂O accumulates, thus generating the dew condensation water 116.

During the high-load continuous power generation, the control unit 22 can ascertain the water state only in a limited way. Accordingly, during the high-load continuous power generation, the control unit 22 in the fuel cell system 10 determines the occurrence of the liquid junction in accordance with the following three methods on the basis of the above determination concept (B). Those three determination methods will be described in detail below one by one.

1) Determination on the basis of the impedance of the fuel cell stack 12

2) Determination on the basis of the current output from the fuel cell stack 12

3) Determination on the basis of the humidity in the fuel cell stack 12

### 1) Regarding Determination on Basis of Impedance of Fuel Cell Stack 12

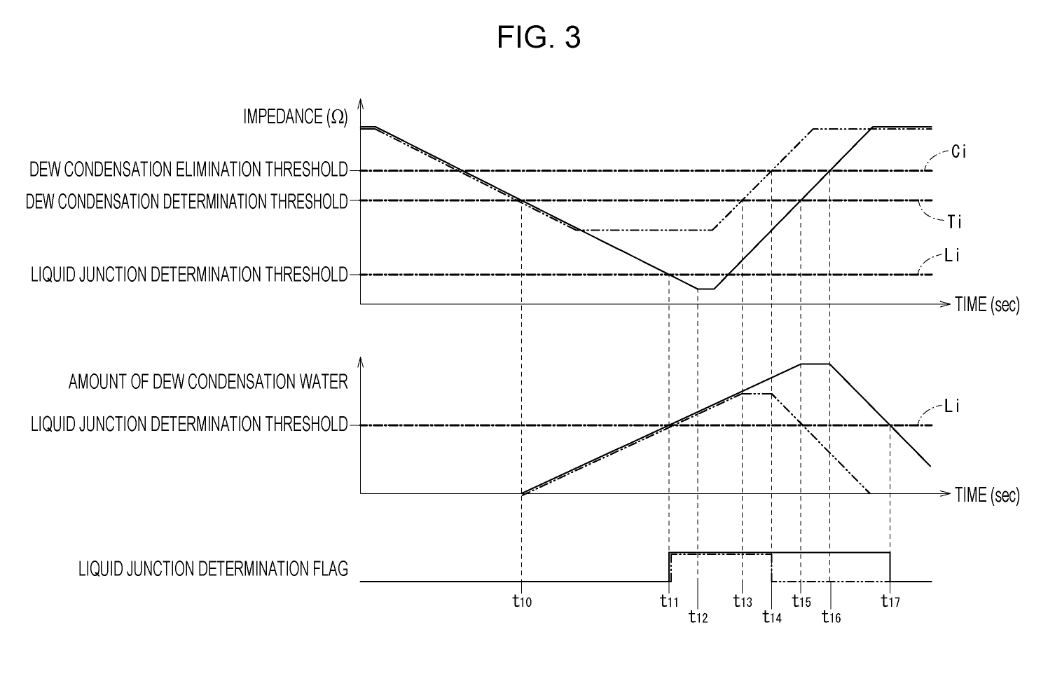

The control unit 22 determines the occurrence of the liquid junction on the basis of the impedance, which is measured by the measurement device 118, by monitoring the impedance of the fuel cell stack 12 during the high-load continuous power generation. As illustrated in FIG. 3, the control unit 22 has a dew condensation determination threshold Ti for impedance depending on a temperature characteristic (driving temperature after the warm-up) of the fuel cell stack 12. Thus, the control unit 22 monitors the impedance sent from the measurement device 118, and determines the generation of the dew condensation water 116 when the monitored impedance has lowered down to the dew condensation determination threshold Ti or below.

Stated in another way, the case of the impedance being lower than the dew condensation determination threshold Ti is estimated to represent a situation where the dew condensation water 116 is continuously generated inside the fuel cell stack 12. Accordingly, the control unit 22 can monitor a total dew condensation water amount by integrating an amount of the dew condensation water 116 generated during a period in which the impedance is lower than the dew condensation determination threshold Ti. For example, at a time t₁₀ in FIG. 3, the control unit 22 determines that the impedance has lowered down to the dew condensation determination threshold Ti or below.

The control unit 22 further has a liquid junction determination threshold Li for impedance depending on the temperature of the fuel cell stack 12. The liquid junction determination threshold Li is an impedance value lower than that corresponding to the dew condensation determination threshold Ti. When the impedance has lowered down to the liquid junction determination threshold Li or below, the fuel cell stack 12 can be regarded as being in a state where a large amount of the dew condensation water 116 is accumulated therein. Accordingly, when the impedance sent from the measurement device 118 has lowered down to the liquid junction determination threshold Li or below, the control unit 22 determines that the liquid junction is occurring.

Referring to a solid line in a graph of FIG. 3, for example, the control unit 22 determines at a time t₁₁ that the impedance has lowered down to the liquid junction determination threshold Li or below, and it sets a liquid junction determination flag. In response to the setting of the liquid junction determination flag, the control unit 22 executes liquid junction elimination control at a time t₁₂. The liquid junction elimination control during the power generation will be described later.

Furthermore, the control unit 22 continues to monitor the impedance even during the execution of the liquid junction elimination control or the low-load power generation. When the impedance rises and then exceeds the dew condensation determination threshold Ti at a time t15, the increase in the amount of the dew condensation water is stopped. However, because the amount of the accumulated dew condensation water is not reduced, the above liquid junction determination is maintained.

When the impedance further rises and then exceeds a dew condensation elimination threshold Ci at a time t16, the amount of the dew condensation water starts to reduce. Thus, in a state where the impedance exceeds the dew condensation elimination threshold Ci, the interior of the fuel cell stack 12 is rather dry. When reaching a time t17, the integrated amount of the dew condensation water is smaller than the liquid junction determination threshold Li. Hence the liquid junction is eliminated. Upon determining the elimination of the liquid junction, the control unit 22 clears the liquid junction determination flag to 0 and brings the liquid junction elimination control to an end.

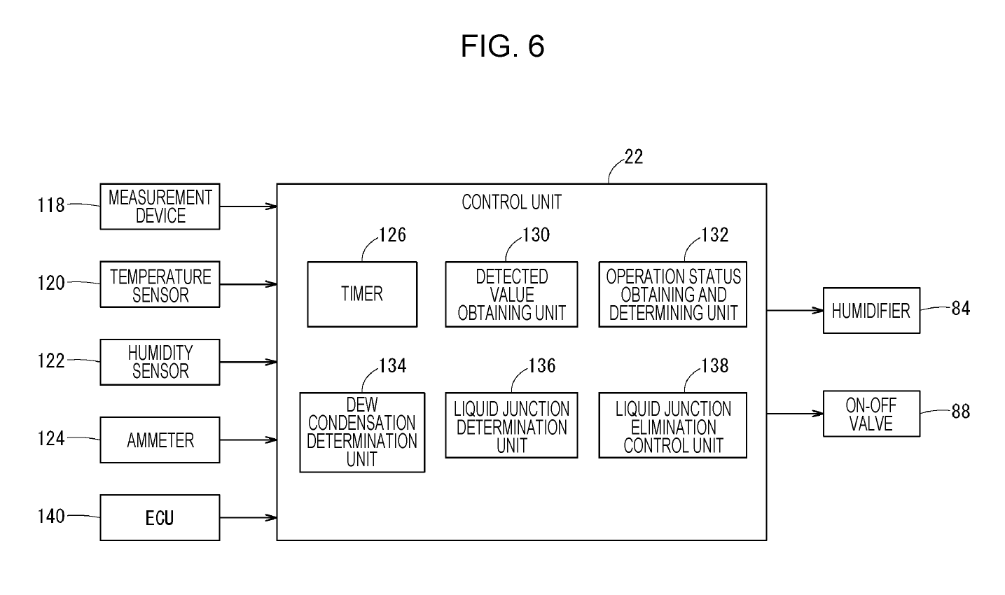

In the determination on the occurrence of the liquid junction on the basis of the impedance, a timer 126 (see FIG. 6) in the control unit 22 may count time from a point of time at which the impedance has lowered down to the dew condensation determination threshold Ti or below, and the control unit 22 may determine the occurrence of the liquid junction when a predetermined time has lapsed from the above point of time. Referring to a two-dot-chain line in the graph of FIG. 3, the lowering of the impedance is suppressed after the impedance has lowered down to the dew condensation determination threshold Ti or below at the time t₁₀. However, if the impedance is still not higher than the dew condensation determination threshold Ti, the amount of the dew condensation water continues to accumulate until the time t₁₁ at which the liquid junction determination flag is set upon determining that the amount of the dew condensation water has exceeded the liquid junction determination threshold Li. Therefore, the liquid junction elimination control is executed from at the time t₁₂.

In the liquid junction elimination control, the impedance exceeds the dew condensation determination threshold Ti at a time t₁₃, and the impedance exceeds the dew condensation elimination threshold Ci at a time t₁₄. Hence the amount of the dew condensation water is reduced after the time t₁₄. When the amount of the dew condensation water is smaller than the liquid junction determination threshold Li, this implies that the liquid junction is eliminated.

Thus, the control unit 22 can satisfactorily determine the occurrence of the liquid junction by utilizing impedance, namely by monitoring the case where the impedance is not higher than the liquid junction determination threshold Li, and the case where the impedance is not higher than the dew condensation determination threshold Ti and such a state continues for a predetermined time.

In the calculation of integrating the amount of the dew condensation water, the control unit 22 may linearly increase the amount of the dew condensation water in accordance with a predetermined proportion constant (dew condensation rate). Alternatively, an approximation formula in relation to an increase in the amount of the dew condensation water depending on the impedance may be determined in advance through experiments, etc., and the amount of the dew condensation water may be integrated using the approximation formula.

Furthermore, depending on the impedance before acceleration of the fuel cell vehicle, i.e., before the start of the high-load continuous power generation, the control unit 22 can predict a time until the occurrence of the liquid junction (or the generation of the dew condensation) during the acceleration. More specifically, when the fuel cell stack 12 under the high-load continuous power generation is in a dry state (i.e., in a high-impedance state), the liquid junction is hard to occur. Therefore, the control unit 22 refers to the impedance of the fuel cell stack 12 before the acceleration, and predicts a longer time as the time until the occurrence of the liquid junction on the basis of judgement that the dew condensation is harder to generate as the impedance is higher. In addition, it is possible to increase the accuracy of the determination and to suppress extra process with respect to the determination on the occurrence of the liquid junction and the liquid junction elimination control by doubly determining the state of the dew condensation water 116 in the fuel cell stack 12 on the basis of both the impedance during the high-load continuous power generation and the time predicted from the impedance before the acceleration.

2) Regarding Determination on Basis of Current Output from Fuel Cell Stack 12

As described above, in the high-load continuous power generation, the current value is not lower than the predetermined value, and the fuel cell system 10 stops the wetting/drying control and operates the fuel cell stack 12 in the wet state. It is hence estimated that the dew condensation water 116 is generated in the fuel cell stack 12.

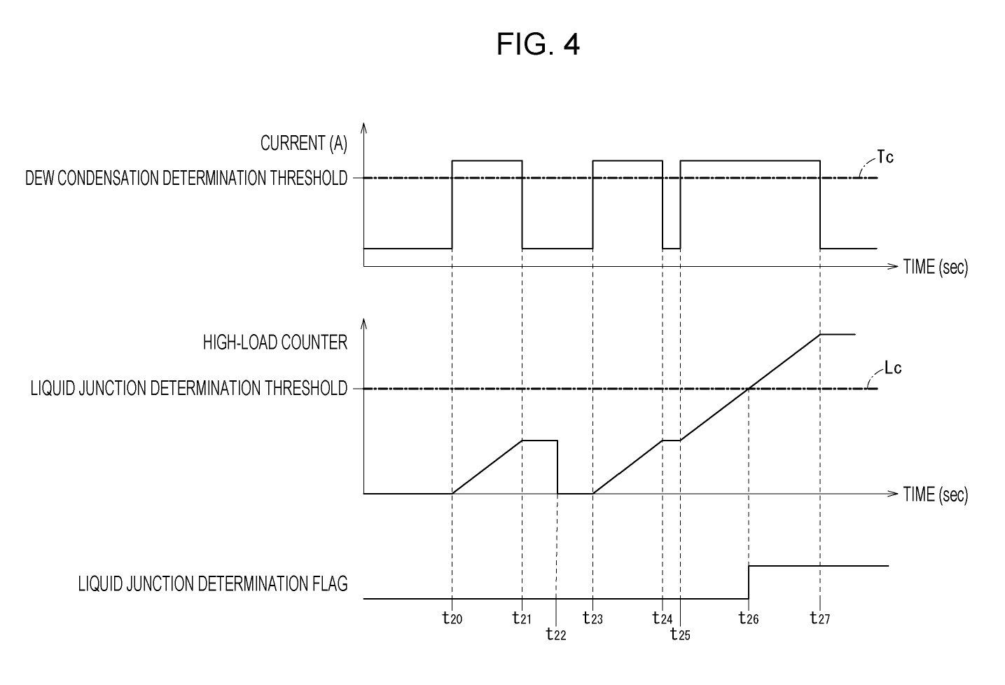

Accordingly, the control unit 22 in the fuel cell system 10 can determine the generation of the dew condensation water 116 on the basis of the fact that the current detected by the ammeter 124 exceeds the predetermined value. As illustrated in FIG. 4, for example, a predetermined value for the detected current (i.e., a dew condensation determination threshold Tc) is set in the control unit 22. When the current increases up to the dew condensation determination threshold Tc or above, the control unit 22 regards a high load as being applied, and increments a count of a high-load counter that counts the application of a high load by the timer 126 (see FIG. 6). The count of the high-load counter starts to be accumulated when the current increases up to the dew condensation determination threshold Tc or above at, for example, a time t₂₀ in FIG. 4.

When the detected current decreases beyond the dew condensation determination threshold Tc, the control unit 22 temporarily stops the counting of the high-load counter, and temporarily maintains the counter state at that time. Then, when the current does not exceed the dew condensation determination threshold Tc during a period in which the counter state is maintained, the high-load counter is reset (returned to 0). This is because, when the current supplied to the load 114 decreases, the fuel cell system 10 operates in a manner of executing the impedance control to make the interior of the fuel cell stack 12 further dried. For example, when the current decreases beyond the dew condensation determination threshold Tc at a time t₂₁ in FIG. 4, the count accumulation by the high-load counter is stopped and the accumulated count is held. The high-load counter is then reset to 0 at a time t₂₂.

On the other hand, when the current exceeds the dew condensation determination threshold Tc again during the period in which the count of the high-load counter is maintained, the count of the high-load counter is incremented again from the count state at that time. For example, it is here assumed that the high-load counter restarts the count when the current exceeds the dew condensation determination threshold Tc at a time t₂₃ in FIG. 4, and that after decreasing beyond the dew condensation determination threshold Tc at a time t₂₄ in FIG. 4, the current exceeds the dew condensation determination threshold Tc again at a time t₂₅ at which the count of the high-load counter is maintained. In the above case, the count is restarted from the maintained state of the high-load counter, and the count of the high-load counter is accumulated again.

A liquid junction determination threshold Lc for the count of the high-load counter is further set in the control unit 22. When the count of the high-load counter increases up to the liquid junction determination threshold Lc or above, the control unit 22 determines the occurrence of the liquid junction, and sets the liquid junction determination flag (see a time t26 in FIG. 4). In response to the setting of the liquid junction determination flag, the control unit 22 executes the liquid junction elimination control.

When the current decreases beyond the dew condensation determination threshold Tc at a time t₂₇ after the setting of the liquid junction determination flag, the control unit 22 maintains the count of the high-load counter for a predetermined period, and resets the high-load counter when the current does not exceed the dew condensation determination threshold Tc again. Also in this case, the liquid junction determination flag is kept set to continue the liquid junction elimination control. As a result, the fuel cell system 10 can reliably eliminate the liquid junction even after the end of the high-load continuous power generation.

### 3) Regarding Determination on Basis of Humidity in Fuel Cell Stack 12

The control unit 22 in the fuel cell system 10 may detect the humidity in the fuel cell stack 12 (specifically, in the membrane electrode assembly 26) by the humidity sensor 122, and may utilize a result of the detection. In other words, whether the fuel cell stack 12 is under an environment where the dew condensation water 116 is generated can be determined by detecting the humidity in the fuel cell stack 12. Therefore, the detected result of the humidity can also be applied to the determination on the occurrence of the liquid junction.

The control unit 22 has a dew condensation determination threshold (e.g., 90%) with respect to the humidity, and sets the humidity of not lower than 90% as a dew condensation region where the dew condensation water 116 is generated. Furthermore, the control unit 22 has a dew condensation elimination threshold (e.g., 50%) with respect to the humidity, and sets the humidity of not higher than 50% as a dry region. When the humidity sent from the humidity sensor 122 is not lower than the dew condensation determination threshold, the control unit 22 determines that the dew condensation water 116 is generated.

In addition, the control unit 22 has a liquid junction determination threshold (e.g., 100%) with respect to the humidity, and can determine the occurrence of the liquid junction when the humidity is not lower than 100%. As an alternative, the control unit 22 may count, by the timer 126, a time during which the detected humidity is not lower than the dew condensation determination threshold, and may determine the occurrence of the liquid junction when a predetermined time has lapsed.

Thus, when the occurrence of the liquid junction is determined on the basis of the humidity, it is also possible to eliminate the liquid junction by setting the liquid junction determination flag and by executing the liquid junction elimination control. Moreover, the control unit 22 can satisfactorily track change in the amount of the dew condensation water by reducing (or resetting) the amount of the dew condensation water when the humidity has lowered down to the dew condensation elimination threshold or below during the liquid junction elimination control or the operation of the fuel cell system 10.

[Determination of Liquid Junction after High-Load Continuous Power Generation]

In the fuel cell system 10, when the load 114 is greatly changed and a low current is output to the load 114 after a high current has been output with the high-load continuous power generation during the acceleration of the fuel cell vehicle, respective amounts of hydrogen gas and air supplied to the fuel cell stack 12 are reduced. It is hence estimated that the capability of discharging water produced with the wet operation in the high-load continuous power generation mode is dropped and the dew condensation water 116 is generated in the fuel cell stack 12.

Accordingly, the control unit 22 in the fuel cell system 10 can determine the occurrence of the liquid junction on the basis of variation (i.e., a variation amount or a variation rate) of the load 114 of the fuel cell vehicle after the high-load continuous power generation. More specifically, when the load 114 takes a high value during the acceleration of the fuel cell vehicle, the current detected by the ammeter 124 is high. Thus, it can be predicted that, if the high current lowers abruptly, the dew condensation water 116 is generated in a short period. In view of the above point, the control unit 22 sets a time from the generation of the dew condensation to the occurrence of the liquid junction depending on change of the detected current (i.e., variation of the load 114 after the high-load continuous power generation).

In order to set the time until the generation of the dew condensation or the occurrence of the liquid junction on the basis of the current, a dew condensation rate, for example, is set depending on the detected current. The dew condensation rate is a proportional constant for correlating the change of the current and the amount of the dew condensation water, and the control unit 22 can calculate the amount of the dew condensation water depending on the variation of the load 114 with the aid of the dew condensation rate. Because the time until reaching the liquid junction is known from the calculated amount of the dew condensation water, the occurrence of the liquid junction can be determined. For example, when the change of the current is larger than a predetermined value, it is possible to immediately determine the occurrence of the liquid junction, and to eliminate the liquid junction in an earlier stage. By doubly determining the occurrence of the liquid junction in the fuel cell stack 12 with additional use of impedance, for example, the control unit 22 can increase the accuracy of the determination and can immediately determine the occurrence of the liquid junction after the high-load continuous power generation. [Determination of Liquid Junction in Warm-up Process]

In the fuel cell system 10, when the power generation is performed in a state where the temperature of the fuel cell stack 12 is low, the dew condensation water 116 is more apt to generate for the reason that the saturated vapor pressure is low and that the capability of discharging water H₂O as water vapor is reduced. In such a case, the amount of the generated dew condensation water is difficult to ascertain, but it can be estimated that some amount of the dew condensation water is generated at a predetermined temperature or below. At the startup of the operation, for example, a warm-up process for raising temperature is performed to increase the power generation efficiency of the fuel cell stack 12. It is thought that the dew condensation water 116 is generated in the warm-up process.

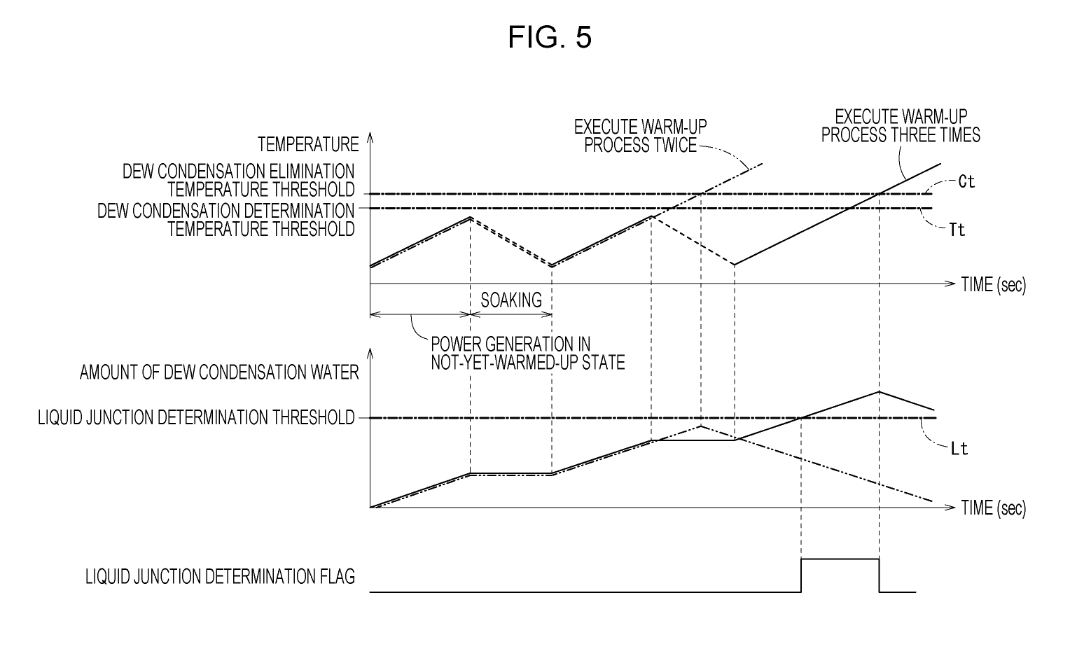

Accordingly, the control unit 22 in the fuel cell system 10 is constituted to perform the determination on the occurrence of the liquid junction in accordance with the above determination concept (C). The control unit 22 performs the determination on the generation of the dew condensation, as illustrated in FIG. 5, by monitoring execution of the warm-up process at a predetermined dew condensation determination temperature threshold Tt or below (i.e., power generation in a not-yet-warmed-up state). The dew condensation determination temperature threshold Tt is 50° C., for example. When the warm-up process is executed at 50° C. or below (namely, when the temperature of the fuel cell stack 12 is 50° C. or below), the control unit 22 determines that the dew condensation is always generated.

In some cases, the operation of the fuel cell system 10 is stopped (subjected to soaking) during the warm-up process for driver's convenience or any other reason. Namely, the fuel cell system is often stopped before the temperature of the fuel cell stack 12 rises sufficiently and the system comes into a state where the power generation efficiency is high. The temperature of the fuel cell stack 12 lowers with the stop of the warm-up process. On the other hand, the dew condensation water 116 is not discharged from the fuel cell stack 12, and the amount of the generated dew condensation water 116 is maintained. Thus, when the operation of the fuel cell system 10 is restarted, the amount of the dew condensation water 116 increases from the preceding state where the dew condensation water 116 remains.

In view of the above point, the control unit 22 is constituted to integrate the amount of the dew condensation water in accordance with the number of executions of the warm-up process at 50° C. or below, or with the execution time (i.e., actual performance of the power generation), and determines the occurrence of the liquid junction when the integrated amount of the dew condensation water exceeds a predetermined liquid junction determination threshold Lt. In the above case, even when the fuel cell system 10 is subjected to soaking, the control unit 22 stores the amount of the dew condensation water generated in the warm-up process, and it integrates the amount of the dew condensation water in the next warm-up process from the stored amount.

In the fuel cell system 10, the amount of the dew condensation water 116 increases proportionally as illustrated in FIG. 5, by way of example, in the warm-up process where the temperature of the fuel cell stack 12 does not exceed 50° C. When the warm-up process at 50° C. or below is repeated three times (see a solid line in a graph of FIG. 5), the integrated amount of the dew condensation water 116 having gradually increased so far exceeds the liquid junction determination threshold Lt. With the integrated amount of the dew condensation water exceeding the liquid junction determination threshold Lt, the control unit 22 determines the occurrence of the liquid junction in the fuel cell stack 12 and sets the liquid junction determination flag.

On the other hand, when the warm-up process is executed twice until the temperature of the fuel cell stack 12 exceeds 50° C. (see a two-dot-chain line in the graph of FIG. 5), the dew condensation water 116 is not accumulated to such an amount as causing the liquid junction even with the dew condensation water 116 being generated in the two warm-up processes. In other words, the temperature of the fuel cell stack 12 exceeds 50° C. before the amount of the dew condensation water exceeds the liquid junction determination threshold Lt. Thus, it can be determined that the warm-up process has ended without causing the liquid junction.

When the temperature of the fuel cell stack 12 has exceeded a predetermined dew condensation elimination temperature threshold Ct, the control unit 22 preferably reduces or resets the integrated amount of the dew condensation water. The dew condensation elimination temperature threshold Ct is 60° C., for example. With that feature, even in the case where the liquid junction has occurred in the warm-up process, unnecessary liquid junction elimination control can be avoided by tracking a situation that the fuel cell stack 12 comes into a dry state from a state of the liquid junction through the operation of the fuel cell stack 12 after the warm-up process. Furthermore, in the case where the liquid junction determination flag is set in the warm-up process and the fuel cell system 10 is stopped before the temperature of the fuel cell stack 12 reaches 60° C., the liquid junction is eliminated by executing the liquid junction elimination control at the stoppage. The liquid junction elimination control at the stoppage will be described below later.

The determination on the occurrence of the liquid junction on the basis of the detected impedance or current value (i.e., the above-described determination concept (A)) may be made in the warm-up process. When the high-load continuous power generation is performed in the warm-up process, the above-described determination concept (B) can also be employed.

### [Liquid Junction Elimination Control During Power Generation]

After setting the liquid junction determination flag in accordance with the above-described determination on the occurrence of the liquid junction, the control unit 22 in the fuel cell system 10 shifts the operation mode to a liquid junction elimination power generation mode and executes the liquid junction elimination control. When the high-load continuous power generation is continued, it is preferable to execute the liquid junction elimination control after the end of the high-load continuous power generation or at proper timing.

In practice, the liquid junction elimination control is executed as control of supplying air in an increased amount to the fuel cell stack 12 (i.e., drying control). As a result, the fuel cell stack 12 can discharge a large amount of moisture in the air flow passage 40 through the air discharge passage 90. Furthermore, the fuel cell system 10 can also increase the amount of air by opening the on-off valve 88 in the bypass supply passage 86 illustrated in FIG. 1 (namely, by reducing a pressure loss in the system). In the above case, because air not passing through the humidifier 84 is supplied from the bypass supply passage 86, drying in the air flow passage 40 can be further promoted.

It is to be noted that the liquid junction elimination control is not limited to the above-mentioned control, and that various types of control capable of promoting drying of the cathode electrode 36 may be executed as required. For example, the control unit 22 may dry the interior of the fuel cell stack 12 by suppressing a degree at which the humidifier 84 humidifies air.

Even when the occurrence of the liquid junction is determined, the fuel cell system 10 may not execute the liquid junction elimination control during the power generation of the fuel cell stack 12. In such a case, the liquid junction is often naturally eliminated with the operation of the fuel cell stack 12 under the continuous power generation for a long time. Furthermore, during the power generation, water H₂O is produced from the catalyst layer 110 and flows toward the gas diffusion layer 112. It is hence supposed that, although the state of the liquid junction has occurred, ions eluted from the separator are suppressed from being taken into the solid polymer electrolyte membrane 32. If the liquid junction determination flag is set when the power generation is stopped, the liquid junction can be eliminated by executing the liquid junction elimination control at the stoppage, and elution of ions from the separator after the stoppage can be prevented.

### [Liquid Junction Elimination Control at Stoppage]

In response to the liquid junction determination flag being set at the stoppage, the control unit 22 in the fuel cell system 10 executes at-stoppage power generation as the liquid junction elimination control. More specifically, by driving the fuel cell stack 12 when the fuel cell system 10 is to be stopped, air in the fuel cell system 10 can be circulated, and the water H₂O in the fuel cell stack 12 can be discharged for drying. Also in the at-stoppage power generation, drying inside the fuel cell stack 12 can be promoted by opening the on-off valve 88 and causing the air to bypass the humidifier 84 in a similar manner to that in the liquid junction elimination control during the power generation.

### [Configuration of Control Unit 22]

A known computer including an input/output interface, a processor, a memory, etc., which are not illustrated, is applied to the control unit 22 in the fuel cell system 10. The control unit 22 constitutes a functional unit for executing the determination on the occurrence of the liquid junction and the liquid junction elimination control with a processor processing a liquid junction determination control program (not illustrated), which is stored in the memory. In more detail, as illustrated in FIG. 6, the control unit 22 includes a detected value obtaining unit 130, an operation status obtaining and determining unit 132, a dew condensation determination unit 134, a liquid junction determination unit 136, a timer 126, and a liquid junction elimination control unit 138.

The detected value obtaining unit 130 periodically receives respective detected values (impedance, current, temperature, and humidity) from the measurement device 118, the ammeter 124, the temperature sensor 120, and the humidity sensor 122, which are connected to the control unit 22, and it stores the detected values in the memory.

The operation status obtaining and determining unit 132 obtains the respective detected values from the measurement device 118, the ammeter 124, the temperature sensor 120, and the humidity sensor 122, or information output from an ECU (electric control unit) 140, etc. in the fuel cell vehicle, and determines the operation status of the vehicle on the basis of the detected values and the information having been obtained. For example, the operation status obtaining and determining unit 132 determines start of driving of the fuel cell vehicle in accordance with turning-on of an ignition, and further determines stop of the driving of the vehicle in accordance with turning-off of the ignition. In addition, the operation status obtaining and determining unit 132 can also determine other statuses of the fuel cell vehicle, such as the warm-up process and the high-load continuous power generation, on the basis of the impedance, the current, and the temperature.

The dew condensation determination unit 134 determines the generation of the dew condensation in the fuel cell stack 12 on the basis of the detected values obtained by the detected value obtaining unit 130. The dew condensation determination unit 134 has the dew condensation determination threshold corresponding to each of the detected values, and determines the generation of the dew condensation water 116 in the fuel cell stack 12, as described above, by comparing the detected value and the dew condensation determination threshold.

The liquid junction determination unit 136 is operated in accordance with a result of the determination on the generation of the dew condensation, which has been made by the dew condensation determination unit 134, and it determines the occurrence of the liquid junction. The liquid junction determination unit 136 has the liquid junction determination threshold with respect to time (such as the amount of the dew condensation water or the count of the high-load counter) or the liquid junction determination threshold with respect to each of the detected values, and determines the occurrence of the liquid junction in the fuel cell stack 12, as described above, by comparing the time or the detected value and the liquid junction determination threshold. When the occurrence of the liquid junction is determined, the liquid junction determination unit 136 sets the liquid junction determination flag. Furthermore, the liquid junction determination unit 136 determines the elimination of the liquid junction on the basis of the detected value(s) after determining the occurrence of the liquid junction, and clears the liquid junction determination flag.

The timer 126 executes time measurement by starting time count at predetermined timing.

The liquid junction elimination control unit 138 is a functional unit for executing the liquid junction elimination control, and it starts the liquid junction elimination control in response to setting of the liquid junction determination flag by the liquid junction determination unit 136. In the liquid junction elimination control, instruction signals are output via the input/output interface to control respective operations of the humidifier 84, the on-off valve 88, etc., as described above, thereby promoting drying inside the fuel cell stack 12. When the liquid junction elimination control is performed at the stoppage of the fuel cell vehicle, the operation of the fuel cell system 10 (i.e., the power generation of the fuel cell stack 12) is continued to eliminate the liquid junction.

### [Execution of Fuel Cell Control Method]

The fuel cell system 10 according to the embodiment is basically constituted as described above. The advantageous effects of the fuel cell system 10 will be described below with reference to an execution flow of a fuel cell control method.

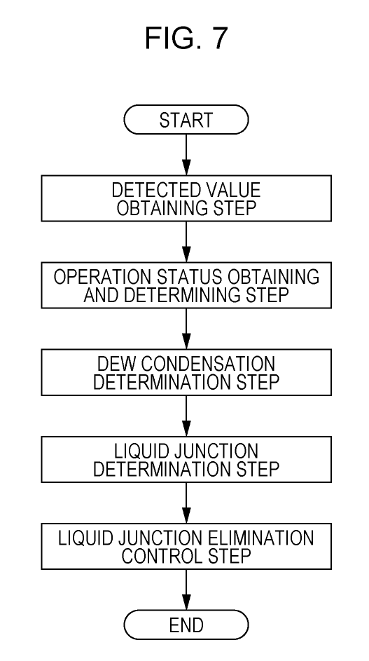

During the operation, the fuel cell system 10 routinely executes the fuel cell control method. According to the fuel cell control method, as illustrated in FIG. 7, the fuel cell system 10 successively executes a detected value obtaining step, an operation status obtaining and determining step, a dew condensation determination step, a liquid junction determination step, and a liquid junction elimination control step. Here, when the control unit 22 in the fuel cell system 10 executes the dew condensation determination step and the liquid junction determination step, it can determine the generation of the dew condensation and the occurrence of the liquid junction by employing at least one of the respective detected value of impedance, current, temperature, and humidity, as described above.

Thus, in the detected value obtaining step, the control unit 22 periodically obtains at least one of the detected values (of impedance, current, temperature, and humidity) and stores the detected value in the memory of the control unit 22.

In the operation status obtaining and determining step, the control unit 22 determines in what status the fuel cell vehicle is present now. For example, the control unit 22 detects turning-on of the ignition in accordance with information from the ECU 140, starts the operation of the fuel cell system 10, and executes the warm-up process of the fuel cell stack 12. Upon determining the execution of the warm-up process, the operation status obtaining and determining unit 132 executes the subsequent step on the basis of a temperature of the fuel cell stack 12, the temperature being detected by the temperature sensor 120.

When the fuel cell vehicle performs the ordinary power generation, or when it performs the high-load continuous power generation during acceleration, for example, the operation status obtaining and determining unit 132 determines whether the low-load continuous power generation or the high-load continuous power generation is performed, on the basis of information (e.g., information of motor driving control) from the ECU 140, a control command to the fuel cell system 10, or the obtained information regarding, e.g., change of the current. Furthermore, in the operation status obtaining and determining step, the statuses before the acceleration of the fuel cell vehicle (before performing the high-load continuous power generation) and after the acceleration (after performing the high-load continuous power generation) are determined on the basis of the obtained information.

When the high-load continuous power generation is performed, the subsequent step is executed on the basis of at least one of the detected values, i.e., the impedance detected by the measurement device 118, the current detected by the ammeter 124, and the humidity detected by the humidity sensor 122. It is to be noted that the operation status obtaining and determining step is not always required to be executed because the control unit 22 can determine the generation of the dew condensation and the occurrence of the liquid junction even when the operation status cannot be recognized only from the detected and obtained values of, e.g., impedance, current, temperature, and humidity.

In the dew condensation determination step, the dew condensation determination unit 134 in the control unit 22 determines whether the dew condensation water 116 is generated in the fuel cell stack 12. More specifically, when it is determined in the operation status obtaining and determining step that the warm-up process is executed, the temperature of the fuel cell stack 12 is basically not higher than the dew condensation determination temperature threshold Tt. Therefore, the dew condensation determination unit 134 always determines the generation of the dew condensation water 116. On the other hand, in the low-load continuous power generation, the dew condensation determination unit 134 compares the impedance with the dew condensation determination threshold Ti, and determines the generation of the dew condensation when the impedance has lowered down to the dew condensation determination threshold Ti or below. In the high-load continuous power generation, the dew condensation determination unit 134 compares the impedance with the dew condensation determination threshold Ti, and determines the generation of the dew condensation when the impedance has lowered down to the dew condensation determination threshold Ti or below. Furthermore, the dew condensation determination unit 134 compares the current with the dew condensation determination threshold Tc, and determines the generation of the dew condensation when the current has increased up to the dew condensation determination threshold Tc or above. Alternatively, the dew condensation determination unit 134 compares the humidity with the dew condensation determination threshold, and determines the generation of the dew condensation when the humidity has increased up to the dew condensation determination threshold or above. The dew condensation determination unit 134 can increase the accuracy of the determination by executing plural types of determination using the plurality of detected values instead of executing only one type of determination using one of the detected values of impedance, current, humidity, and temperature.

In the liquid junction determination step, the liquid junction determination unit 136 in the control unit 22 determines whether the liquid junction occurs in the fuel cell stack 12, and sets the liquid junction determination flag when the occurrence of the liquid junction is determined. In the case of the warm-up process being executed, the liquid junction determination unit 136 holds the number of times of the execution and the execution time of the warm-up process during a period in which the temperature of the fuel cell stack 12 has not risen sufficiently. Then, the liquid junction determination unit 136 determines the occurrence of the liquid junction when the warm-up process has been repeated over three times, by way of example, as illustrated in FIG. 5.

When the impedance is used as the detected value in the low-load continuous power generation or the high-load continuous power generation, the liquid junction determination unit 136 compares the impedance with the liquid junction determination threshold Li, and determines the occurrence of the liquid junction when the impedance has lowered down to the dew condensation determination threshold Li or below, as illustrated in FIG. 3. Alternatively, in the case of the determination using impedance, the liquid junction determination unit 136 counts a time after determining the generation of the dew condensation, and calculates an increase in the amount of the dew condensation water. Then, the liquid junction determination unit 136 determines the occurrence of the liquid junction when the amount of the dew condensation water has increased up to the liquid junction determination threshold Li or above.

When the current is used as the detected value in the high-load continuous power generation, the liquid junction determination unit 136 monitors a time during which the current is not lower than the dew condensation determination threshold Tc (namely, it increments the counts of the high-load counter), as illustrated in FIG. 4. Then, the liquid junction determination unit 136 determines the occurrence of the liquid junction when the count of the high-load counter has increased up to the dew condensation determination threshold Lc or above with the lapse of a predetermined time. Similarly, when the humidity is used as the detected value in the high-load continuous power generation, the liquid junction determination unit 136 counts a time during which the humidity is not lower than the dew condensation determination threshold. Then, the liquid junction determination unit 136 determines the occurrence of the liquid junction when the amount of the dew condensation water has increased up to the liquid junction determination threshold or above with the lapse of a predetermined time.

In the liquid junction elimination control step, the liquid junction elimination control unit 138 executes the liquid junction elimination power generation mode in response to the setting of the liquid junction determination flag by the liquid junction determination unit 136. More specifically, in the liquid junction elimination power generation mode, the liquid junction elimination control unit 138 opens the on-off valve 88 and supplies air having low humidity to the fuel cell stack 12, thereby promoting drying inside the fuel cell stack 12 (specifically, the air flow passage 40). Then, the control unit 22 determines, on the basis of the detected value(s), whether the liquid junction has been eliminated after determining the occurrence of the liquid junction. When the liquid junction has been eliminated, the liquid junction determination flag is returned to 0, and the liquid junction elimination power generation mode is ended. When the liquid junction determination flag is set at the stoppage of the power generation, the operation of the fuel cell system 10 is ended after executing the at-stoppage power generation and eliminating the liquid junction in the fuel cell stack 12.

As described above, the fuel cell system 10 and the fuel cell control method according to the embodiment are designed to determine, on the basis of at least one of various detected values, whether the state of the liquid junction occurs, and to perform an operation of making the fuel cell dried when the occurrence of the liquid junction is determined. On the other hand, a related-art system is not designed to determine the state of the liquid junction in which water droplets are not appeared in flow passages inside the fuel cell stack 12. Thus, according to the embodiment, since the occurrence of the liquid junction is determined, the state of the liquid junction can be suppressed from remaining during stoppage of the operation of the fuel cell stack 12, for example. As a result, in the fuel cell system 10, it is possible to suppress elution of ions from the separator and deterioration of the solid polymer electrolyte membrane 32, and to increase durability of the fuel cell stack 12.

Since the occurrence of the liquid junction is determined in the liquid junction determination step when the power generation in the not-yet-warmed-up state has been performed the predetermined number of times or for the predetermined time, the occurrence of the liquid junction during the power generation in the not-yet-warmed-up state can be determined in a simple manner. Moreover, since the occurrence of the liquid junction is determined in the liquid junction determination step when the high-load continuous power generation has continued for the predetermined time or longer or when the detected value has lowered down to the predetermined liquid junction determination threshold or below, the occurrence of the liquid junction during the high-load continuous power generation can be determined in a simple manner.

Furthermore, in the liquid junction determination step, the occurrence of the liquid junction is determined when the power generation mode has shifted from the high-load continuous power generation to a mode in which the load 114 is reduced by a predetermined amount of change. As a result, the occurrence of the liquid junction immediately after the high-load continuous power generation can be determined in a simple manner. Alternatively, in the liquid junction determination step, the time until performing the determination on the occurrence of the liquid junction is set to be longer as the impedance before the start of the high-load continuous power generation has a higher value. Accordingly, the occurrence of the liquid junction can be determined with higher reliability. The reason resides in that it would be harder to determine the occurrence of the liquid junction if the fuel cell stack 12 is dry before the start of the high-load continuous power generation.

Since, in the liquid junction elimination control step, the on-off valve 88 is opened and not-humidified air is supplied to the fuel cell stack 12, a region between the solid polymer electrolyte membrane 32 and the separator can be dried easily. Furthermore, since, in the liquid junction elimination control step, the power generation is continued to make the fuel cell stack 12 dried when the fuel cell stack 12 is to be stopped, the state of the liquid junction can be prevented from occurring after the stoppage of the power generation. Thus, deterioration of the fuel cell stack 12 attributable to elution of ions can be prevented reliably. Moreover, even in the case of not executing the liquid junction elimination control step before stopping the fuel cell stack 12, deterioration of the fuel cell stack 12 can be prevented by eliminating the state of the liquid junction at the time of stopping the fuel cell stack 12, while drying control can be avoided from being unnecessarily executed during the power generation.

It is needless to say that the present application is not limited to the above-described embodiment, and that a variety of modifications can be made within the scope not departing from the gist of the present application.

The present application provides a fuel cell control method including a detected value obtaining step of, during an operation of a fuel cell including membrane electrode assemblies and separators stacked successively, detecting a status variable of the fuel cell and obtaining a detected value of the status variable, each of the membrane electrode assemblies including a solid polymer electrolyte membrane sandwiched between an anode electrode and a cathode electrode, a liquid junction determination step of determining, on the basis of the detected and obtained value, whether a state of liquid junction in which the solid polymer electrolyte membrane and the separator are interconnected through a liquid occurs, and a liquid junction elimination control step of performing an operation of making the fuel cell dried when the occurrence of the liquid junction is determined.

According to the fuel cell control method described above, since whether the state of the liquid junction occurs is determined on the basis of the detected value and the operation of making the fuel cell dried is performed when the occurrence of the liquid junction is determined, the liquid junction having occurred in the fuel cell is eliminated satisfactorily. Stated in another way, a related-art system is not designed to determine the state of the liquid junction in which water droplets are not appeared in flow passages inside the fuel cell stack. On the other hand, according to the present application, since the occurrence of the liquid junction is determined, the state of the liquid junction can be suppressed from remaining during stoppage of the fuel cell, for example. As a result, in the fuel cell, it is possible to suppress not only ions, which have been eluted from the separator, from being taken into the solid polymer electrolyte membrane, but also deterioration of the solid polymer electrolyte membrane, and to increase durability of the fuel cell.

In this connection, preferably, in the liquid junction determination step, the occurrence of the liquid junction is determined when power generation in a not-yet-warmed-up state, which is defined as power generation being stopped before a temperature of the fuel cell, obtained as the detected value, reaches a temperature threshold, has been performed a predetermined number of times or for a predetermined time.

With the feature described above, since, in the liquid junction determination step, the occurrence of the liquid junction is determined when the power generation in the not-yet-warmed-up state has been performed the predetermined number of times or for the predetermined time, the occurrence of the liquid junction during the power generation in the not-yet-warmed-up state can be determined in a simple manner.

Preferably, the fuel cell performs high-load continuous power generation in which an amount of water produced during the operation of the fuel cell exceeds an amount of water discharged from the fuel cell, and in the liquid junction determination step, the occurrence of the liquid junction is determined when the high-load continuous power generation has continued for a predetermined time or longer, or when the detected value has lowered down to a predetermined liquid junction determination threshold or below.

With the features described above, since the occurrence of the liquid junction is determined in the liquid junction determination step when the high-load continuous power generation has continued for the predetermined time or longer or when the detected value has lowered down to the predetermined liquid junction determination threshold or below, the occurrence of the liquid junction during the high-load continuous power generation can be determined in a simple manner.

Preferably, the fuel cell performs high-load continuous power generation in which an amount of water produced during the operation of the fuel cell exceeds an amount of water discharged from the fuel cell, and in the liquid junction determination step, the occurrence of the liquid junction is determined when a power generation mode has shifted from the high-load continuous power generation to a mode in which a load supplied with electric power from the fuel cell is reduced by a predetermined amount of change.

With the features described above, since the occurrence of the liquid junction is determined when the power generation mode has shifted from the high-load continuous power generation to the mode in which the load is reduced by the predetermined amount of change, the occurrence of the liquid junction immediately after the high-load continuous power generation can be determined in a simple manner.

Alternatively, the fuel cell may perform high-load continuous power generation in which an amount of water produced during the operation of the fuel cell exceeds an amount of water discharged from the fuel cell, and in the liquid junction determination step, a time until performing the determination on the occurrence of the liquid junction may be set to be longer as an impedance of the fuel cell, obtained as the detected value, has a higher value before start of the high-load continuous power generation.

With the feature described above, since, in the liquid junction determination step, the time until performing the determination on the occurrence of the liquid junction is set to be longer as the impedance before the start of the high-load continuous power generation has a higher value, the occurrence of the liquid junction can be with higher reliability. The reason resides in that it would be harder to determine the occurrence of the liquid junction if the fuel cell is dry before the high-load continuous power generation.

Preferably, air humidified through a humidifier is supplied to the cathode electrode during the power generation of the fuel cell, and in the liquid junction elimination control step, an on-off valve bypassing the humidifier is opened and air not passing through the humidifier is supplied to the fuel cell.

With the features described above, since, in the liquid junction elimination control step, the on-off valve is opened and not-humidified air is supplied to the fuel cell, a region between the solid polymer electrolyte membrane and the separator can be dried easily.

Preferably, when the occurrence of the liquid junction is determined in the liquid junction determination step at time of stopping the fuel cell, the power generation of the fuel cell is continued to make the fuel cell dried in the liquid junction elimination control step.

With the feature described above, since, in the liquid junction elimination control step, the power generation is continued to make the fuel cell dried when the fuel cell is to be stopped, the state of the liquid junction can be prevented from occurring after stopping the power generation. Thus, deterioration of the fuel cell attributable to elution of ions can be prevented reliably even when a standby period after the stoppage is long.

In addition, the fuel cell control method may be modified not to execute the liquid junction elimination control step before stopping the fuel cell.

With the feature described above, drying control can be avoided from being unnecessarily executed during the power generation. Thus, even in the case of not executing the liquid junction elimination control step before stopping the fuel cell, deterioration of the fuel cell can be prevented by eliminating the state of the liquid junction at the time of stopping the fuel cell.

Furthermore, the present application provides a fuel cell system including a fuel cell that includes membrane electrode assemblies and separators stacked successively, each of the membrane electrode assemblies including a solid polymer electrolyte membrane sandwiched between an anode electrode and a cathode electrode, the fuel cell system including a detected value obtaining unit of, during an operation of the fuel cell, detecting a status variable of the fuel cell and obtaining a detected value of the status variable, a liquid junction determination unit of determining, on the basis of the detected and obtained value, whether a state of liquid junction in which the solid polymer electrolyte membrane and the separator are interconnected through a liquid occurs, and a liquid junction elimination control unit of performing an operation of making the fuel cell dried when the occurrence of the liquid junction is determined.

With the fuel cell control method and the fuel cell system according to the present application, elution of ions and deterioration of the membranes in the fuel cell can be suppressed by determining the occurrence of the liquid junction and by eliminating the state of the liquid junction.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell control method comprising:
a detected value obtaining step of, during an operation of a fuel cell including membrane electrode assemblies and separators stacked successively, detecting a status variable of the fuel cell and obtaining a detected value of the status variable, each of the membrane electrode assemblies including a solid polymer electrolyte membrane sandwiched between an anode electrode and a cathode electrode;
a liquid junction determination step of determining, on the basis of the detected and obtained value, whether a state of liquid junction in which the solid polymer electrolyte membrane and the separator are interconnected through a liquid occurs; and
a liquid junction elimination control step of performing an operation of making the fuel cell dried when the occurrence of the liquid junction is determined.

2. The fuel cell control method according to claim 1, wherein, in the liquid junction determination step, the occurrence of the liquid junction is determined when power generation in a not-yet-warmed-up state, which is defined as power generation being stopped before a temperature of the fuel cell, obtained as the detected value, reaches a temperature threshold, has been performed a predetermined number of times or for a predetermined time.

3. The fuel cell control method according to claim 1, wherein the fuel cell performs high-load continuous power generation in which an amount of water produced during the operation of the fuel cell exceeds an amount of water discharged from the fuel cell, and
in the liquid junction determination step, the occurrence of the liquid junction is determined when the high-load continuous power generation has continued for a predetermined time or longer, or when the detected value has lowered down to a predetermined liquid junction determination threshold or below.

4. The fuel cell control method according to claim 1, wherein the fuel cell performs high-load continuous power generation in which an amount of water produced during the operation of the fuel cell exceeds an amount of water discharged from the fuel cell, and
in the liquid junction determination step, the occurrence of the liquid junction is determined when a power generation mode has shifted from the high-load continuous power generation to a mode in which a load supplied with electric power from the fuel cell is reduced by a predetermined amount of change.

5. The fuel cell control method according to claim 1, wherein the fuel cell performs high-load continuous power generation in which an amount of water produced during the operation of the fuel cell exceeds an amount of water discharged from the fuel cell, and
in the liquid junction determination step, a time until performing the determination on the occurrence of the liquid junction is set to be longer as an impedance of the fuel cell, obtained as the detected value, has a higher value before start of the high-load continuous power generation.

6. The fuel cell control method according to claim 1, wherein air humidified through a humidifier is supplied to the cathode electrode during the power generation of the fuel cell, and
in the liquid junction elimination control step, an on-off valve bypassing the humidifier is opened and air not passing through the humidifier is supplied to the fuel cell.

7. The fuel cell control method according to claim 1, wherein, when the occurrence of the liquid junction is determined in the liquid junction determination step at time of stopping the fuel cell, the power generation of the fuel cell is continued to make the fuel cell dried in the liquid junction elimination control step.

8. The fuel cell control method according to claim 7, wherein the liquid junction elimination control step is not executed before stopping the fuel cell.

9. A fuel cell system including a fuel cell that includes membrane electrode assemblies and separators stacked successively, each of the membrane electrode assemblies including a solid polymer electrolyte membrane sandwiched between an anode electrode and a cathode electrode, the fuel cell system comprising:
a detected value obtaining unit of, during an operation of the fuel cell, detecting a status variable of the fuel cell and obtaining a detected value of the status variable;
a liquid junction determination unit of determining, on the basis of the detected and obtained value, whether a state of liquid junction in which the solid polymer electrolyte membrane and the separator are interconnected through a liquid occurs; and
a liquid junction elimination control unit of performing an operation of making the fuel cell dried when the occurrence of the liquid junction is determined.

10. A fuel cell control method comprising:
detecting a state value indicating a state in a fuel cell during an operation of the fuel cell which includes a membrane electrode assembly and a separator stacked on the membrane electrode assembly, the membrane electrode assembly including a solid polymer electrolyte membrane sandwiched between an anode electrode and a cathode electrode;
determining whether a liquid connects the solid polymer electrolyte membrane and the separator based on the state value detected; and
drying the fuel cell in a case where it is determined that the liquid connects the solid polymer electrolyte membrane and the separator.

11. The fuel cell control method according to claim 10, wherein it is determined that the liquid connects the solid polymer electrolyte membrane and the separator when power generation in a not-yet-warmed-up state, which is defined as power generation being stopped before a temperature of the fuel cell, obtained as the state value detected, reaches a temperature threshold, has been performed a predetermined number of times or for a predetermined time.

12. The fuel cell control method according to claim 10, wherein the fuel cell performs high-load continuous power generation in which an amount of water produced during the operation of the fuel cell exceeds an amount of water discharged from the fuel cell, and
it is determined that the liquid connects the solid polymer electrolyte membrane and the separator when the high-load continuous power generation has continued for a predetermined time or longer, or when the detected state value has lowered down to a predetermined liquid junction determination threshold or below.

13. The fuel cell control method according to claim 10, wherein the fuel cell performs high-load continuous power generation in which an amount of water produced during the operation of the fuel cell exceeds an amount of water discharged from the fuel cell, and
it is determined that the liquid connects the solid polymer electrolyte membrane and the separator when a power generation mode has shifted from the high-load continuous power generation to a mode in which a load supplied with electric power from the fuel cell is reduced by a predetermined amount of change.

14. The fuel cell control method according to claim 10, wherein the fuel cell performs high-load continuous power generation in which an amount of water produced during the operation of the fuel cell exceeds an amount of water discharged from the fuel cell, and
a time until determining that the liquid connects the solid polymer electrolyte membrane and the separator is set to be longer as an impedance of the fuel cell, obtained as the state value detected, has a higher value before start of the high-load continuous power generation.

15. The fuel cell control method according to claim 10, wherein air humidified through a humidifier is supplied to the cathode electrode during power generation of the fuel cell, and
in determining whether the liquid connects the solid polymer electrolyte membrane and the separator, an on-off valve bypassing the humidifier is opened and air not passing through the humidifier is supplied to the fuel cell.

16. The fuel cell control method according to claim 10, wherein, when it is determined that the liquid connects the solid polymer electrolyte membrane to the separator at time of stopping the fuel cell, the power generation of the fuel cell is continued to make the fuel cell dried.

17. The fuel cell control method according to claim 16, wherein the fuel cell is not dried before stopping the fuel cell.

18. A fuel cell system comprising:
a fuel cell comprising:
a membrane electrode assembly including a solid polymer electrolyte membrane sandwiched between an anode electrode and a cathode electrode; and
a separator stacked on the membrane electrode assembly;
a detector to detect a state value indicating a state in a fuel cell during an operation of the fuel cell; and
circuitry configured to
determine whether a liquid connects the solid polymer electrolyte membrane and the separator based on the state value detected; and
dry the fuel cell in a case where it is determined that the liquid connects the solid polymer electrolyte membrane and the separator.
